(19) United States
(12) Patent Application Publication
(10) Pub. No.: US 2012/0212823 A1
(43) Pub. Date: Aug. 23, 2012

(54) TUNABLE INTERFERENCE FILTER, OPTICAL MODULE, AND PHOTOMETRIC ANALYZER

(75) Inventors: Tatsuaki FUNAMOTO, Shiojiri (JP); Tatsuo URUSHIDANI, Chino (JP)

(73) Assignee: SEIKO EPSON CORPORATION, Tokyo (JP)

(21) Appl. No.: 13/398,066

(22) Filed: Feb. 16, 2012

(30) Foreign Application Priority Data
Feb. 17, 2011 (JP) 2011-032149

(51) Int. Cl. G02B 5/28

(52) U.S. Cl. 359/578

(57) ABSTRACT

An etalon as a tunable interference filter includes a first substrate, a second substrate, a fixed mirror, a movable mirror, and an electrostatic actuator. The respective mirrors are formed by stacking one layer of a TiO₂ film and one layer of an alloy film. A film thickness dimension of the TiO₂ film and a film thickness dimension of the Ag alloy film are set to film thicknesses such that reflectance of a reference wavelength may be target reflectance and reflectance of a set wavelength may be lower than that of the case where the reflection film is formed only by the metal film.

### BACKGROUND

1. Technical Field

The present invention relates to a tunable interference filter, an optical module including the tunable interference filter, and a photometric analyzer including the optical module.

2. Related Art

In related art, a tunable interference filter (optical filter) in which mirrors (a pair of mirrors) as reflection films are respectively oppositely provided via a gap on surfaces opposed to each other of a pair of substrates has been known (for example, see Patent Document 1 (JP-A-2009-251105)).

In the tunable interference filter of Patent Document 1, incident lights are multiple-interfered between the pair of mirrors, and lights having specific wavelengths strengthened with each other by multiple interference are transmitted. In this regard, the wavelengths of the transmitted lights are changed by changing the dimension of the gap between the mirrors.

The tunable interference filter of Patent Document 1 may form a photometric analyzer in combination with a light source and a light receiver. The photometric analyzer is a device of analyzing colors of a test object by applying light from the light source to an object to be measured, entering reflected light into the tunable interference filter, and receiving the light transmitted through the tunable interference filter by the light receiver.

In the case where an analysis is performed in a visible light range, generally, a tungsten light source is used as the light source. The spectrum of the tungsten light source has many longer wavelength components and the light receiver (detector) as a silicon photodiode or the like has higher sensitivity at the longer wavelength side. Further, typically, the characteristics of a bandpass filter (tunable interference filter) in respective wavelength ranges are designed to have nearly equal transmittance (amount of transmission lights).

However, from the characteristics of the above described light source and the light receiver, the amount of light at the longer wavelength side becomes larger to about ten times to tens of times the amount of light at the shorter wavelength side. Thereby, especially, at the shorter wavelength side, it is necessary to significantly amplify a light receiver output by an amplifier, and this reduces an S/N ratio as a result and the measurement accuracy becomes lower.

### SUMMARY

An advantage of some aspects of the invention is to provide a tunable interference filter and an optical module that enable high-accuracy measurement with a higher S/N ratio when incorporated into a photometric analyzer, and a photometric analyzer that may perform high-accuracy measurement.

An aspect of the invention is directed to a tunable interference filter including a first substrate, a second substrate mutually opposed to the first substrate, a first reflection film provided on a surface of the first substrate facing the second substrate, a second reflection film provided on the second substrate and opposed to the first reflection film via a gap, and a gap dimension setting unit that sets a dimension of the gap by changing the dimension of the gap, wherein the first reflection film and the second reflection film are respectively formed by stacking one layer of a transparent film and one layer of a metal film, a film thickness of the transparent film and a film thickness of the metal film are set to film thicknesses such that reflectance of the reflection film at a reference wavelength set in advance may be target reflectance set in advance and reflectance of a set wavelength set in a shorter wavelength range in a transmission wavelength range may be lower than reflectance at the set wavelength if the reflection film is formed only by the metal film and the reflectance of the reference wavelength is set to the target reflectance, and light having a wavelength in response to the dimension of the gap set by the gap dimension setting unit is transmitted.

Here, the transmission wavelength range is a set range of wavelengths transmitted using the tunable interference filter according to the aspect of the invention. For example, in the case where the range is set so that wavelengths from 400 to 700 nm may be transmitted for transmission of visible lights, the range is a range from 400 to 700 nm. Therefore, the shorter wavelength range of the transmission wavelength range refers to a predetermined range containing a lower limit of the range. In the case where the transmission wavelength range is set to the range from 400 to 700 nm, the shorter wavelength range may be set to a range from 400 to 450 nm, for example.

Further, the reference wavelength is a wavelength for reference at setting of the film thickness set within the transmission wavelength range, and is set to a median value of the transmission wavelength range, for example.

Furthermore, the set wavelength is a wavelength set in the shorter wavelength range in the transmission wavelength range, and is set to a lower limit of the shorter wavelength range, for example.

According to the aspect of the invention, the film thickness of the transparent film and the film thickness of the metal film in the respective reflection films are set to film thicknesses such that reflectance in the shorter wavelength range of the transmission wavelength range may be lower than that of a single metal film.

In the tunable interference filter, in the visible light range (for example, from 400 to 700 nm), there is a tendency that the reflectance at the shorter wavelength side (for example, from 400 to 450 nm) is lower and the reflectance at the longer wavelength side (for example, from 650 to 700 nm) is higher. Accordingly, the typical tunable interference filter has been set so that the reflectance in the shorter wavelength range may be higher than that in the case of the single metal film using an interference film as an under layer and the change in reflectance in the visible light range may be smaller.

On the other hand, in the aspect of the invention, contrary to the related art, the reflectance in the shorter wavelength range is made lower than that in the case of the single metal film for increasing the amount of transmission light in the shorter wavelength range. Thereby, in the case where a photometric analyzer is formed by combining a typical light source such as a tungsten light source having many components in the longer wavelength range than those in the shorter wavelength range and a light receiver having higher sensitivity in the longer wavelength range with the tunable interference filter according to the aspect of the invention, the difference in output between the shorter wavelength side and the longer wavelength side may be made smaller to less than ten times than that in the related art. Therefore, by forming the photometric analyzer using the tunable interference filter according to the aspect of the invention, the amplification ratio of the output at the shorter wavelength side may be made smaller, the S/N ratio may be made higher, and high-accuracy measurement may be performed.

In the tunable interference filter according to the aspect of the invention, it is preferable that the first reflection film is formed by sequentially stacking one layer of the transparent film and one layer of the metal film from the first substrate side, and the second reflection film is formed by sequentially stacking one layer of the transparent film and one layer of the metal film from the second substrate side.

According to this configuration, in addition to the above described advantages, the respective reflection films are formed by sequentially stacking one layer of the transparent film and one layer of the metal film from the substrate side, and the reflection films may be formed by directly deposited on the substrates. Thereby, the reflection films may be formed stably on the substrates, and deflection or the like may be suppressed.

In the tunable interference filter according to the aspect of the invention, it is preferable that the metal film is an Ag alloy film containing silver (Ag) as a main component.

According to this configuration, the metal film is formed by the Ag alloy film. As the interference filter, it is necessary to realize high resolution and high transmittance, and it is preferable to use an Ag film advantageous in reflection characteristics and transmission characteristics as a material that satisfies the condition. On the other hand, the Ag film is liable to deterioration in an environmental temperature and a manufacturing process. In this regard, by using the Ag alloy film, the deterioration due to the environmental temperature and the manufacturing process may be suppressed and the high resolution and the high transmittance may be realized.

In the tunable interference filter according to the aspect of the invention, it is preferable that the transparent film is a titanium dioxide (TiO₂) film.

According to this configuration, for the transparent film, the TiO₂ film with a high refractive index is used. Accordingly, fluctuations of a desired half width may be suppressed. Thereby, the light transmittance may be improved and the resolution of the interference filter may be further improved.

In the tunable interference filter according to the aspect of the invention, it is preferred that the first substrate and the second substrate are glass substrates, and a refractive index of the transparent film is higher than refractive indices of the first substrate and the second substrate.

According to this configuration, a material of the respective substrates is formed by glass having a refractive index lower than the refractive index of the transparent film, and thereby, high transmittance may be realized without reduction of the light transmittance.

Another aspect of the invention is directed to an optical module including the above described tunable interference filter, and a light receiving unit that receives test object light transmitted through the tunable interference filter.

According to the aspect of the invention, the optical module may reduce an output range (fluctuation width) from the shorter wavelength range to the longer wavelength range in the above described transmission wavelength range, the S/N ratio may be made higher, and high-accuracy measurement may be performed.

Still another aspect of the invention is directed to a photometric analyzer including the above described optical module, and an analytical processing unit that analyzes light properties of the test object light based on the light received by the light receiving unit of the optical module.

According to the aspect of the invention, the photometric analyzer includes the optical module having the above described tunable interference filter, and thereby, high-accuracy measurement of the amount of light may be performed and correct spectroscopic characteristics may be measured by performing photometric analytical processing based on the measurement result.

### BRIEF DESCRIPTION OF THE DRAWINGS

The invention will be described with reference to the accompanying drawings, wherein like numbers reference like elements.

FIG. 1 is a block diagram showing a schematic configuration of a colorimetric instrument of one embodiment according to the invention.

FIG. 2 is a sectional view showing a schematic configuration of an etalon of the embodiment.

FIG. 3 is a graph showing relationships between thicknesses of TiO₂ films and reflectance.

FIG. 4 is a graph showing relationships between thicknesses of TiO₂ films and reflectance of a set wavelength of 400 nm in the embodiment.

FIG. 5 is a graph showing comparisons in amounts of light between the case without the TiO₂ film and the cases of the thicknesses of 0.2Q and 1.6Q in the embodiment.

FIG. 6 is a graph showing relationships between thicknesses of TiO₂ films and reflectance at the set wavelength of 400 nm in the embodiment.

FIG. 7 is a graph showing relationships between wavelength ranges and amounts of light in examples according to the invention.

FIG. 8 is a graph showing a light amount ratio relative to the amount of light at the set wavelength of 400 nm in the examples according to the invention.

### DESCRIPTION OF EXEMPLARY EMBODIMENTS

Embodiments of the invention will be explained with reference to the drawings.

### 1. Schematic Configuration of Colorimetric Instrument

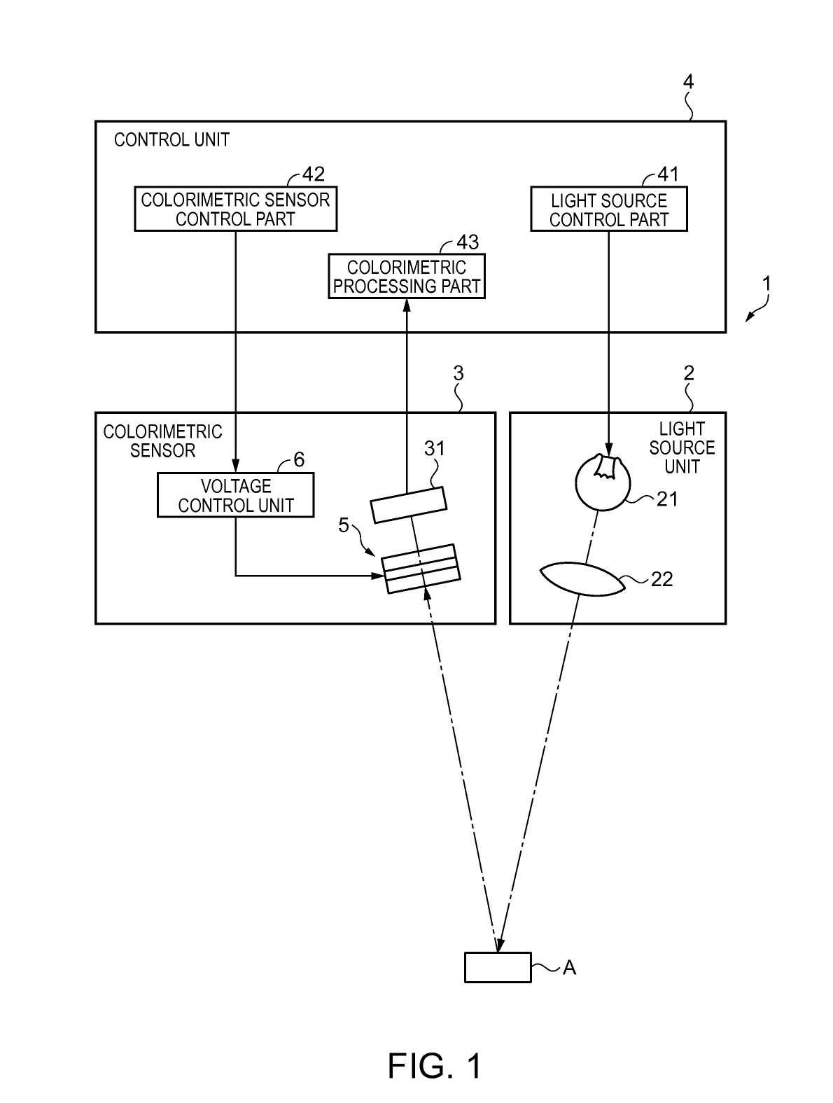

FIG. 1 is a block diagram showing a schematic configuration of a colorimetric instrument 1 (photometric analyzer) of the embodiment.

As shown in FIG. 1, the colorimetric instrument 1 includes a light source unit 2 that outputs light to a test object A, a colorimetric sensor 3 (optical module), and a control unit 4 that controls the entire operation of the colorimetric instrument 1.

Further, the colorimetric instrument 1 is a device that reflects the light output from the light source unit 2 on the test object A, receives reflected test object light in the colorimetric sensor 3, and analyzes and measures the chromaticity of the test object light, i.e., the color of the test object A based on a detection signal output from the colorimetric sensor 3.

### 2. Configuration of Light Source Unit

The light source unit 2 includes a light source 21 and plural lenses 22 (only one is shown in FIG. 1), and outputs white light to the test object A. The light source 21 is a tungsten lamp, for example.

Further, the plural lenses 22 may include a collimator lens, and, in this case, the light source unit 2 brings the white light output from the light source 21 into parallel light by the collimator lens and outputs it from a projection lens (not shown) toward the test object A. Note that, in the embodiment, the colorimetric instrument 1 including the light source unit 2 is exemplified, however, for example, in the case where the test object A is a light emitting member such as a liquid crystal panel, the light source unit 2 may not be provided.

### 3. Configuration of Colorimetric Sensor

The colorimetric sensor 3 includes an etalon 5 (tunable interference filter), a light receiving device 31 (light receiving unit) that receives light transmitted through the etalon 5, and a voltage control unit 6 that varies a wavelength of the light transmitted through the etalon 5 as shown in FIG. 1. Further, the colorimetric sensor 3 includes an incidence optical lens or a concave mirror (not shown) that guides the reflected light (test object light) reflected on the test object A inward in a position facing the etalon 5. Further, the colorimetric sensor 3, using the etalon 5 spectroscopically separates light having a predetermined wavelength as a wavelength to be measured of the test object lights entering from the incidence optical lens, and receives the spectroscopically separated light by the light receiving device 31.

The light receiving device (detector) 31 includes plural photoelectric conversion elements (for example, silicon photodiodes) and generates electric signals in response to amounts of received light. Further, the light receiving device 31 is connected to the control unit 4, and outputs the generated electric signals as light reception signals to the control unit 4.

### 3-1. Configuration of Etalon

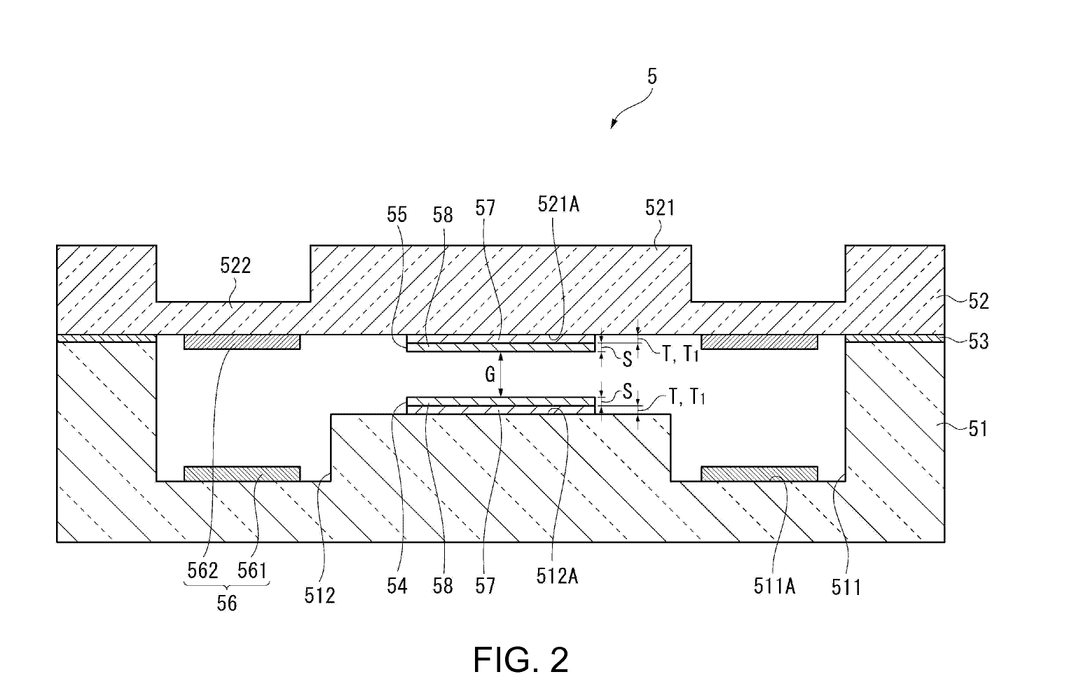

FIG. 2 is a sectional view showing a schematic configuration of the etalon 5 in the embodiment.

The etalon 5 is a plate-like optical member having a square shape in a plan view, and one side is formed in 10 mm, for example. The etalon 5 includes a first substrate 51 and a second substrate 52 as shown in FIG. 2. Further, the substrates 51, 52 are bonded to each other via a bonding layer 53 by siloxane bonding using a plasma-polymerized film and integrally formed, for example.

Here, the first substrate 51 and the second substrate 52 are formed using a material having a refractive index lower than a refractive index n of a TiO₂ film 57 as a transparent film, which will be described later. Specifically, various kinds of glass of soda glass, crystalline glass, quartz glass, lead glass, potassium glass, borosilicate glass, alkali-free glass, etc. may be exemplified.

Further, a fixed mirror 54 (first reflection film) and a movable mirror 55 (second reflection film) are provided between the first substrate 51 and the second substrate 52. Here, the fixed mirror 54 is fixed to a surface of the first substrate 51 facing the second substrate 52, and the movable mirror 55 is fixed to a surface of the second substrate 52 facing the first substrate 51. Furthermore, the fixed mirror 54 and the movable mirror 55 are oppositely provided via a gap G.

In addition, an electrostatic actuator 56 for adjustment of the dimension of the gap G between the fixed mirror 54 and the movable mirror 55 is provided between the first substrate 51 and the second substrate 52.

The electrostatic actuator 56 has a first electrode 561 provided at the first substrate 51 side and a second electrode 562 provided at the second substrate 52 side, and these electrodes are oppositely provided. The first electrode 561 and the second electrode 562 are respectively connected to the voltage control unit 6 (see FIG. 1) via electrode lead parts (not shown).

Further, by a voltage output from the voltage control unit 6, an electrostatic attractive force acts between the first electrode 561 and the second electrode 562, the dimension of the gap G is adjusted, and a transmission wavelength of the light transmitted through the etalon 5 is determined in response to the gap G. That is, by appropriately adjusting the gap G using the electrostatic actuator 56, the light transmitted through the etalon 5 is determined and the light transmitted through the etalon 5 is received by the light receiving device 31.

Therefore, a gap dimension setting unit in the etalon 5 is formed by the electrostatic actuator 56. The gap dimension setting unit of the embodiment is adapted to vary the dimension of the gap G in a range from 140 to 300 nm. Thereby, the etalon 5 is set to transmit light at 400 to 700 nm of a visible light range as a transmission wavelength range.

Next, the fixed mirror 54 and the movable mirror 55 will be explained and the detailed configuration of the etalon 5 will be described later.

### 3-1-1. Configuration of Fixed Mirror and Movable Mirror

The fixed mirror 54 and the movable mirror 55 are respectively formed in two-layer structures in which one layer of the titanium oxide (TiO₂) film 57 (transparent film) and one layer of a silver (Ag) alloy film 58 (metal film) are sequentially stacked from the substrate side of the respective substrates 51, 52.

The Ag alloy film 58 of the embodiment is an Ag—Sm—Cu alloy film containing silver (Ag), samarium (Sm), and copper (Cu). Further, though the illustration is omitted, an oxide film of silicon (Si) covers the Ag alloy film 58 as a protective film. Note that, in the embodiment, the oxide film of silicon (Si) is used as the protective film, however, an oxide film of aluminum (Al), a fluoride film of magnesium (Mg), or the like may be used.

Film thickness dimensions S, T of the Ag alloy film 58 and the TiO₂ film 57 are set according to the reflectance of a single plate having a film configuration to be explained.

The single plate has the TiO₂ film 57 and the Ag alloy film 58 stacked on a glass substrate like the respective substrates 51, 52. Note that the thickness of the glass substrate of the single plate is set to 2 mm.

The film thickness dimension S of the Ag alloy film 58 is set with a reference wavelength λ₀ of 560 nm so that the reflectance of the light on the single plate may be 91%. Here, the reference wavelength λ₀ is a wavelength arbitrarily determined for film thickness setting, and 560 nm as a wavelength nearly intermediate in the visible light range of 400 to 700 nm is selected in the embodiment. Note that the reference wavelength λ₀ is not limited to 560 nm, but may be 550 nm, 570 nm, or the like and may be set to an intermediate value of the transmission wavelength range in the colorimetric instrument 1 or the like.

Further, the reflectance of 91% is determined based on a half width set in the etalon 5. That is, the reflectance of the single plate and the half width as the etalon 5 has a correlation, and the reflectance is set to 91% so that the half width may be about 20 nm in the embodiment. Therefore, the set value of the reflectance is not limited to 91% of the embodiment, may be determined to 90%, 92%, or the like based on the setting of the half width in the etalon 5.

In the case where only the Ag alloy film 58 is stacked on the glass substrate under the above condition, that is, in the case where no TiO₂ film 57 is provided, the film thickness dimension S of the Ag alloy film 58 is set to 41 nm.

On the other hand, in the case where the TiO₂ film 57 is stacked, the film thickness dimension S of the Ag alloy film 58 also changes depending on the film thickness dimension T of the TiO₂ film 57.

For example, when the film thickness dimension T of the TiO₂ film 57 is 0.2Q, the film thickness dimension S of the Ag alloy film 58 is set to 44 nm. Similarly, when the film thickness dimension T of the TiO₂ film 57 is 0.4Q, 0.6Q, 0.8Q, 1.0Q, 1.2Q, 1.4Q, 1.6Q, 1.8Q, 2.0Q, 2.2Q, 2.4Q, 2.6Q, 2.8Q, 3.0Q, 3.2Q, 3.4Q, the film thickness dimension S of the Ag alloy film 58 is set to 44, 48, 49, 47, 44, 40, 38, 37, 38, 40, 43, 47, 49, 48, 45, 41, 38 nm, respectively.

They are set so that, when the light having the reference wavelength λ₀ of 560 nm enters the single plate, the reflectance may be nearly 91%.

Here, Q=λ/4n. λ is the reference wavelength λ₀ and n is the refractive index of the TiO₂ film 57. 0.2 to 3.4 is a factor. In the embodiment, 0.2Q=11.312 nm, 0.4Q is 22.624 nm twice the 0.2Q, and 3.4Q is about 192 nm.

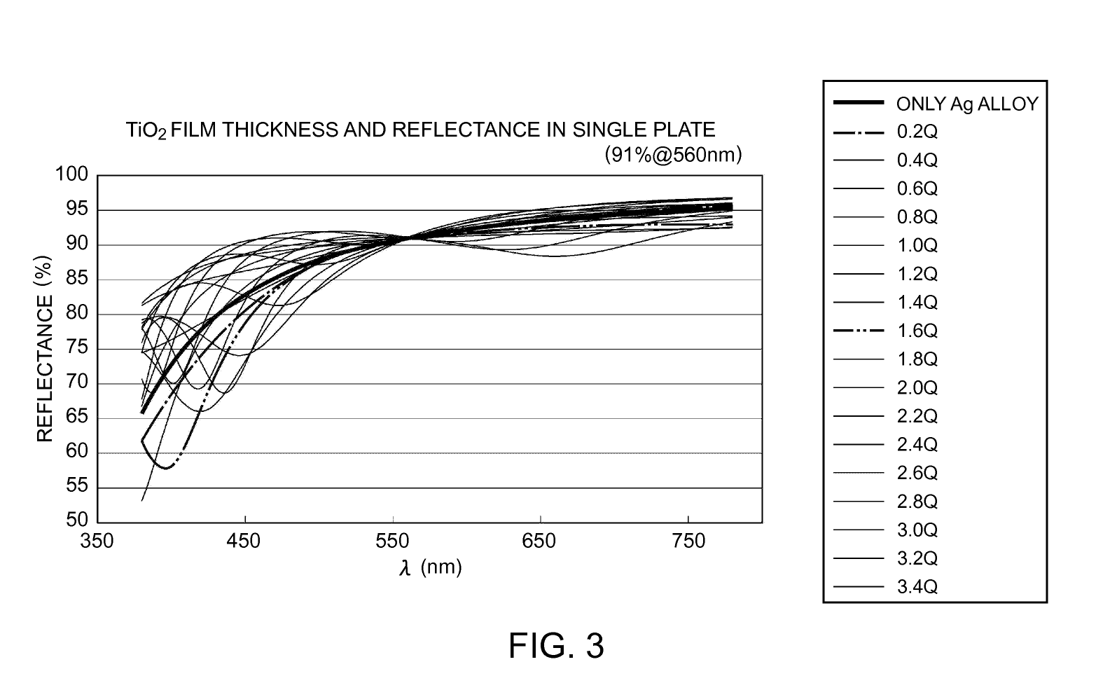

FIG. 3 shows spectral reflectance in the single plate when the film thickness dimension T of the TiO₂ film 57 is changed. As is clear from FIG. 3, on the whole, the reflectance is lower at the shorter wavelength side and higher at the longer wavelength side. Further, it is known that, at the shorter wavelength side, the reflectance may be lower or higher depending on the film thickness dimension T of the TiO₂ film 57 compared to the case of only the Ag alloy film 58.

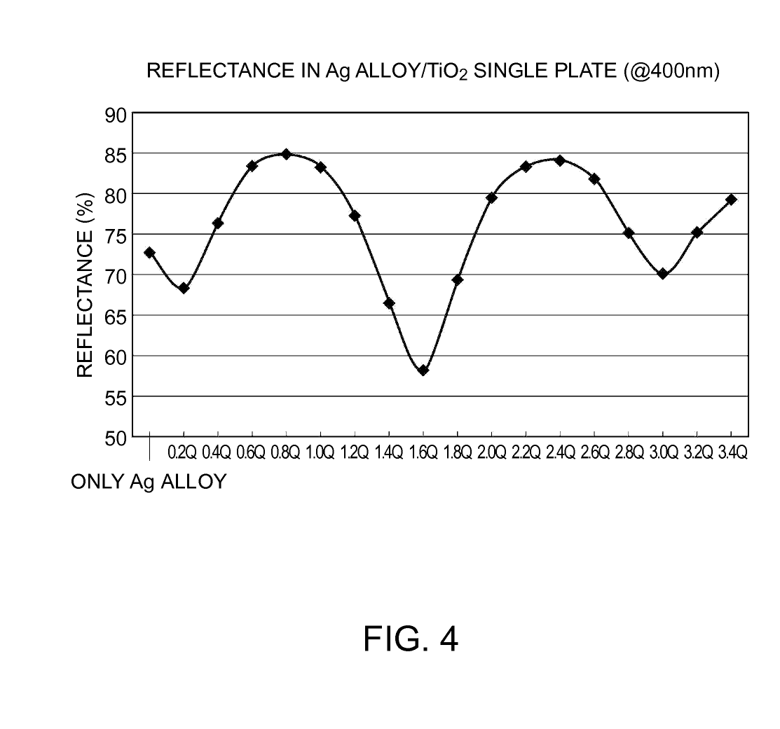

FIG. 4 shows relationships between the reflectance of light at 400 nm as the set wavelength and the respective film thickness dimensions T of the TiO₂ film 57. In the embodiment, 400 nm as a lower limit from 400 to 700 nm as the transmission wavelength range is used as the set wavelength.

As shown in FIG. 4, the reflectance of 400 nm periodically changes in response to the film thickness dimension of the TiO₂ film 57.

In FIG. 4, a part in which the reflectance is lower than that in the case of only the Ag alloy film 58 at a left end is a 0.2Q part, an 1.6Q part, and a 3.0Q part.

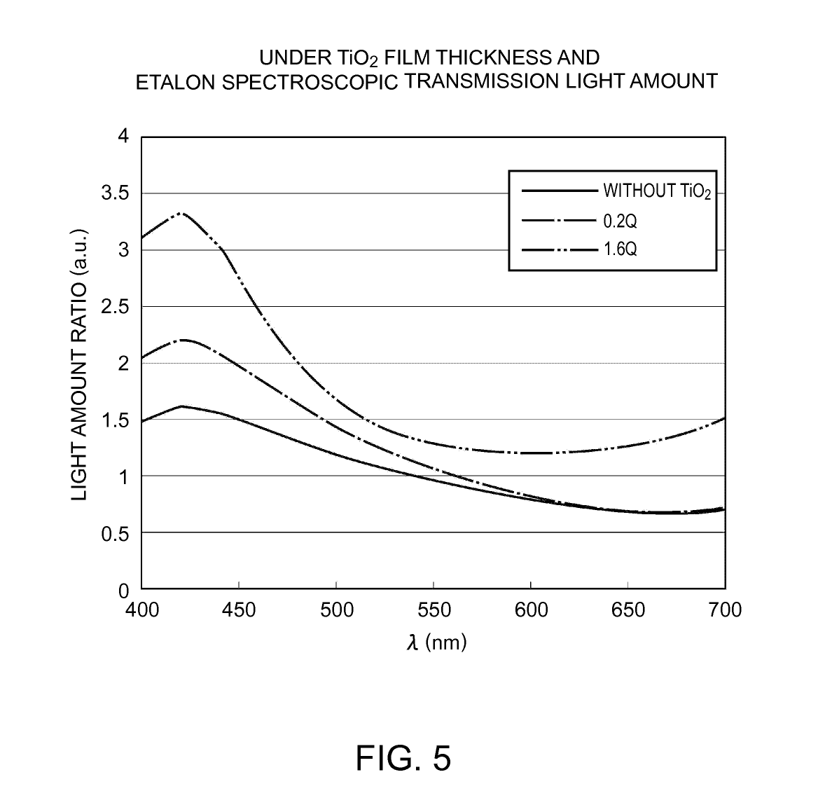

Accordingly, FIG. 5 shows comparisons in amount of transmission light of the etalon 5 between the cases where the TiO₂ film 57 and the Ag alloy film 58 are stacked as the reflection films of the first substrate 51 and the second substrate 52 and the film thickness dimension T of the TiO₂ film 57 is set to 0.2Q and 1.6Q and the case where only the Ag alloy film 58 is used (without the TiO₂ film 57). Note that the film thickness dimension T of 3.0Q is not plotted because it has few advantages compared to 0.2Q and 1.6Q. That is, for 3.0Q, the film thickness is as thick as about 192 nm. When the film thickness is thicker, the weight of the Ag alloy film 58 is also greater and, if it is used for the movable mirror 55, the variable operation of the gap G is affected. As shown in FIG. 4, in the case of 3.0Q, the reduction effect of the reflectance is smaller and the possibility of actually using it is lower in consideration of the disadvantage of the larger film thickness.

As shown in FIG. 5, in the cases of 0.2Q and 1.6Q, compared to the case without TiO₂ film 57, the amount of transmission light tends to be larger at the shorter wavelength side. Accordingly, when the film thickness dimension of the TiO₂ film 57 is set to 0.2Q or 1.6Q, the amount of transmission light at the shorter wavelength side may be made larger compared to the case of only the Ag alloy film 58. Therefore, in the colorimetric instrument 1 using the light source 21 having many components at the longer wavelength side and the light receiving device 31 having higher sensitivity at the longer wavelength side, an output range of the light receiving device 31 may be suppressed from the shorter wavelength range to the longer wavelength range.

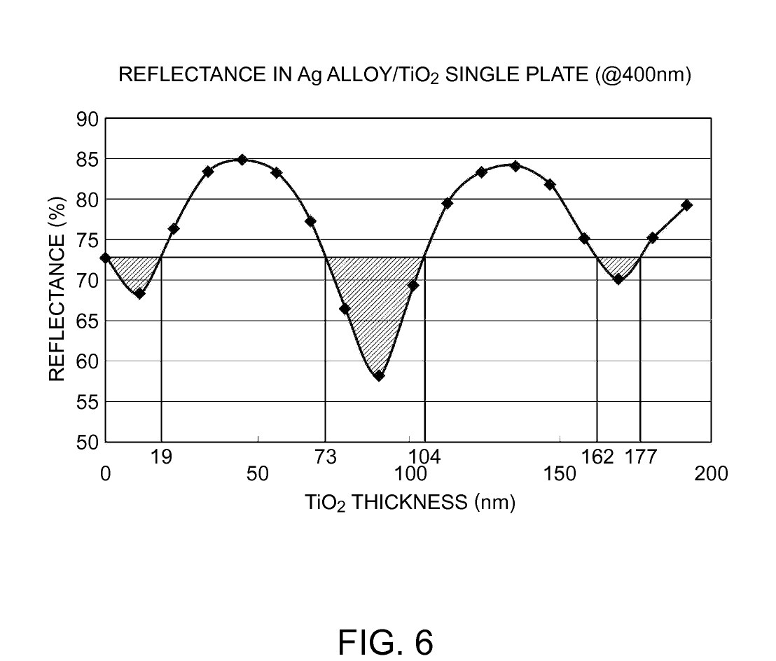

Accordingly, in the embodiment, as shown in FIG. 6, the film thickness dimension T of the TiO₂ film 57 may be set to a dimension such that the reflectance at 400 nm may be lower than that in the case of only the Ag alloy film 58 (thickness of TiO₂=0 in FIG. 6).

In the embodiment, the film thickness dimension may roughly be set in three film thickness ranges. The first range is a range containing 0.2Q. Note that, because the control of the film thickness is difficult when the film thickness is too small, in the embodiment, a range from 11 to 19 nm is set to the first range with 0.2Q=about 11 nm with which the reflectance is the lowest in the first range as a lower limit.

Further, the second range is a range containing 1.6Q specifically from 73 to 104 nm.

Furthermore, the third range is a range containing 3.0Q specifically from 162 to 177 nm.

Note that, in the embodiment, the TiO₂ film 57 is used as the transparent film according to the invention, however, it is necessary to use a film with a higher refractive index than those of the first substrate 51 and the second substrate 52 and, for example, titanium nitride, zirconia, an oxide film of tantalum (Ta), an oxide film of niobium (Nb), or the like may be used. Of them, the TiO₂ film having the high refractive index and exhibiting good transmission characteristics to light in the visible light range is preferable.

The film thickness dimension S of the Ag alloy film 58 is set in response to the film thickness of the TiO₂ film 57 in a range from 37 to 49 nm as described above.

Particularly, if the film thickness dimension S of the Ag alloy film 58 is less than 30 nm, the film thickness dimension S is too small and the reflectance of the Ag alloy film 58 is lower and the reduction of the reflectance due to process working or changes over time becomes greater. Further, in the case where the Ag alloy film 58 is formed by sputtering, the sputtering rate of the Ag alloy film 58 is higher, and the control of the film thickness may be difficult and reduction of manufacturing stability may be caused.

On the other hand, if the film thickness dimension S of the Ag alloy film 58 exceeds 60 nm, the light transmittance becomes lower and the functions as the fixed mirror 54 and the movable mirror 55 of the etalon 5 also become lower.

From the point of view, it is preferable to set the film thickness dimension S of the Ag alloy film 58 forming the fixed mirror 54 and the movable mirror 55 equal to or more than 30 nm and equal to or less than 60 nm. There is no problem because the first to third ranges of the embodiment are contained within the range.

Further, the Ag—Sm—Cu alloy film containing silver (Ag), samarium (Sm), and copper (Cu) is used as the Ag alloy film 58, however, the following alloy films may be used.

That is, as the Ag alloy film 58, an Ag—C alloy film containing silver (Ag) and carbon (C), an Ag—Pd—Cu alloy film containing silver (Ag), palladium (Pd), and copper (Cu), an Ag—Bi—Nd alloy film containing silver (Ag), bismuth (Bi), and neodymium (Nd), an Ag—Ga—Cu alloy film containing silver (Ag), gallium (Ga), and copper (Cu), an Ag—Au alloy film containing silver (Ag) and gold (Au), an Ag—In—Sn alloy film containing silver (Ag), indium (In), and tin (Sn), an Ag—Cu alloy film containing silver (Ag) and copper (Cu), or the like may be used.

Further, as the metal film according to the invention, a metal film using another metal than Ag may be employed, and, for example, a pure gold (Au) film, an alloy film containing gold (Au), a pure copper (Cu) film, or an alloy film containing copper (Cu) may be used. Note that, in the case where the visible light range is set to the wavelength range to be measured, the Ag alloy film is optimal in advantageous transmission characteristics and reflection characteristics and resistance to deterioration. If a space in which the mirrors 54, 55 are placed is made vacuous, materials such as the Ag film liable to deterioration due to oxidation may be used.

### 3-1-2. Configuration of First Substrate

The first substrate 51 is formed by processing a glass base material having a thickness of 500 μm, for example, by etching. As shown in FIG. 2, an electrode formation groove 511 and a mirror fixing part 512 are formed on the first substrate 51 by etching.

In the electrode formation groove 511, a ring-shaped electrode fixing surface 511A is formed between an outer circumferential edge of the mirror fixing part 512 and an inner circumferential wall of the electrode formation groove 511. The above described first electrode 561 is formed in a ring shape on the electrode fixing surface 511A.

The mirror fixing part 512 is formed in a cylindrical shape having a smaller diameter dimension than that of the electrode formation groove 511 coaxially with the electrode formation groove 511 as described above. Further, a mirror fixing surface 512A of the mirror fixing part 512 facing the second substrate 52 is formed nearer the second substrate 52 than the electrode fixing surface 511A. On the mirror fixing surface 512A, the above described fixed mirror 54 is formed.

### 3-1-3. Configuration of Second Substrate

The second substrate 52 is formed by processing a glass base material having a thickness dimension of 200 μm, for example, by etching.

Specifically, the second substrate 52 includes a movable part 521 having a circular shape around a substrate center point in a plan view seen in a substrate thickness direction (hereinafter, “etalon plan view”) and a connection holding part 522 that is coaxial with the movable part 521, formed in an annual shape in the etalon plan view, and holds the movable part 521 movably in the thickness direction of the second substrate 52.

The movable part 521 is formed to have a film thickness dimension larger than that of the connection holding part 522, and, for example, in the embodiment, formed to have the same dimension of 200 μm as the thickness dimension of the second substrate 52. Further, on a movable surface 521A of the movable part 521 at the side facing the first substrate 51, the above described movable mirror 55 is formed.

The connection holding part 522 is a diaphragm surrounding the movable part 521 and formed in a thickness dimension of 50 μm, for example. On a surface of the connection holding part 522 facing the first substrate 51, the above described second electrode 562 is formed in a ring shape.

### 3-2. Configuration of Voltage Control Unit

The voltage control unit 6 controls voltages applied to the first electrode 561 and the second electrode 562 of the electrostatic actuator 56 based on control signals input from the control unit 4.

### 4. Configuration of Control Unit

The control unit 4 controls the entire operation of the colorimetric instrument 1. As the control unit 4, for example, a general-purpose personal computer, a portable information terminal, and additionally, a colorimetry-dedicated computer or the like may be used.

Further, the control unit 4 includes a light source control part 41, a colorimetric sensor control part 42, a colorimetric processing part 43 (analytical processing part), etc. as shown in FIG. 1.

The light source control part 41 is connected to the light source unit 2. Further, the light source control part 41 outputs a predetermined control signal to the light source unit 2 based on a setting input by a user, for example, and allows the light source unit 2 to output white light with predetermined brightness.

The colorimetric sensor control part 42 is connected to the colorimetric sensor 3. Further, the colorimetric sensor control part 42 sets the wavelength of light to be received by the colorimetric sensor 3 based on the setting input by the user, for example, and outputs a control signal for detection of the amount of received light having the wavelength to the colorimetric sensor 3. Thereby, the voltage control unit 6 of the colorimetric sensor 3 sets the voltage applied to the electrostatic actuator 56 so that the wavelength of the light desired by the user may be transmitted based on the control signal.

The colorimetric processing part 43 controls the colorimetric sensor control part 42 to vary the gap between the mirrors of the etalon 5 and changes the wavelength of the light transmitted through the etalon 5. Further, the colorimetric processing part 43 acquires the amount of light transmitted through the etalon 5 based on a light reception signal input from the light receiving device 31. Furthermore, the colorimetric processing part 43 calculates the chromaticity of light reflected by the test object A based on the amounts of received light of the respective wavelengths obtained as above.

### 5. Advantages of Embodiment

According to the embodiment, the film thickness of the TiO₂ film 57 as the transparent film and the film thickness of the Ag alloy film 58 as the metal film of the respective mirrors 54, 55 are set to film thicknesses with which the reflectance at the set wavelength of 400 nm is lower than that of the single metal film. Accordingly, in the etalon 5, the amount of transmission light in the shorter wavelength range may be increased. Thereby, in the case where the colorimetric instrument 1 is formed by combining the typical light source 21 such as a tungsten light source having many components at the longer wavelength side than those at the shorter wavelength side and the light receiving device 31 having higher sensitivity at the longer wavelength side with the etalon 5, the difference in output between the shorter wavelength side and the longer wavelength side may be made smaller to less than ten times than that in related art. Therefore, in the calorimetric instrument 1, an amplification ratio of the output at the shorter wavelength side of the light receiving device 31 may be made smaller, an S/N ratio may be made higher, and high-accuracy measurement may be performed.

According to the embodiment, the respective mirrors 54, 55 are formed by sequentially stacking one layer of the TiO₂ film 57 and one layer of the Ag alloy film 58 from the substrate side. In the configuration, for example, compared to a configuration in which only a metal film is formed on a substrate and a configuration in which a dielectric multilayer film is formed on a substrate and a metal film is provided thereon, absorbance of a specific wavelength by the metal film may be suppressed and reduction of amount of transmission light and reduction of resolution of the etalon 5 may be suppressed. Thereby, the resolution of the etalon 5 may be improved without reduction of the amount of transmission light in the longer wavelength range of near-infrared light.

Further, the metal film is formed by the Ag alloy film 58. As the etalon 5, it is necessary to realize high resolution and high transmittance, and it is preferable to use the Ag film advantageous in reflection characteristics and transmission characteristics as the material that satisfies the condition. On the other hand, the Ag film is liable to deterioration in the environmental temperature and the manufacturing process. In this regard, by using the Ag alloy film 58, the deterioration due to the environmental temperature and the manufacturing process may be suppressed and the high resolution and the high transmittance may be realized.

Furthermore, since the film thickness dimension S of the Ag alloy film 58 is from 30 nm to 60 nm, the transmittance of the light entering the Ag alloy film 58 is not lower and sufficient transmittance may be maintained.

In addition, for the transparent film, the TiO₂ film 57 with the high refractive index is used. Accordingly, fluctuations of the desired half width may be suppressed. Thereby, the light transmittance may be improved and the resolution of the etalon 5 may be further improved.

Moreover, since the TiO₂ film 57 is set so that the reflectance at the reference wavelength λ₀ may be about 91%, the desired half width (for example, 20 nm) may be kept nearly constant in a predetermined wavelength-tunable range. Thereby, the reduction of transmittance in the longer wavelength range may be suppressed and the resolution of the etalon 5 may be improved.

Since the material of the respective substrates 51, 52 is formed by glass with the smaller refractive index than the refractive index of the TiO₂ film 57, the higher transmittance may be realized without the reduction of the light transmittance.

### Modifications of Embodiment

Note that the invention is not limited to the above described embodiment, but modifications, alternations, etc. within the range in which the purpose of the invention may be achieved are included in the invention.

In the embodiment, as the gap dimension setting unit, the configuration in which the gap G between the mirrors is adjustable by the electrostatic actuator 56 has been exemplified, however, for example, a configuration in which an electromagnetic actuator having an electromagnetic coil and a permanent magnet or a piezoelectric device that can be expanded and contracted by voltage application is provided may be employed.

In the embodiment, the respective substrates 51, 52 have been bonded by the bonding layer 53, however, not limited to that. For example, a configuration of bonding by a so-called cold activation bonding in which no bonding layer 53 is formed, bonding surfaces of the respective substrates 51, 52 are activated and the activated bonding surfaces are stacked and pressurized for bonding may be employed, or any bonding method may be used.

In the embodiment, the thickness dimension of the second substrate 52 has been set to 200 μm, for example, however, the substrate may be set to 500 μm equal to that of the first substrate 51. In this case, the thickness dimension of the movable part 521 becomes as thick as 500 μm, and deflection of the movable mirror 55 may be suppressed and the respective mirrors 54, 55 may be maintained further parallel.

In the embodiment, the colorimetric sensor 3 has been exemplified as the optical module according to the invention and the colorimetric instrument 1 including the colorimetric sensor 3 has been exemplified as the photometric analyzer, however, not limited to those. For example, a gas sensor that allows a gas to flow into the sensor and detects light absorbed by the gas of incident light may be used as the optical module according to the invention, and a gas detector that analyzes and discriminates the gas flowing into the sensor by the gas sensor may be used as the photometric analyzer according to the invention. Further, the photometric analyzer may be a spectroscopic camera, a spectroscopic analyzer, or the like including the above-described optical module.

Further, by changing the intensity of lights at the respective wavelengths with time, data can be transmitted using the light at the respective wavelengths. In this case, the lights having the specific wavelength is spectroscopically separated by the etalon 5 provided in the optical module and received by the light receiving unit, and thereby, data transmitted by the light having the specific wavelength may be extracted. Using the photometric analyzer including the optical module for data extraction, the data of the lights at the respective wavelengths is processed, and thereby, optical communication may be performed.

### EXAMPLES

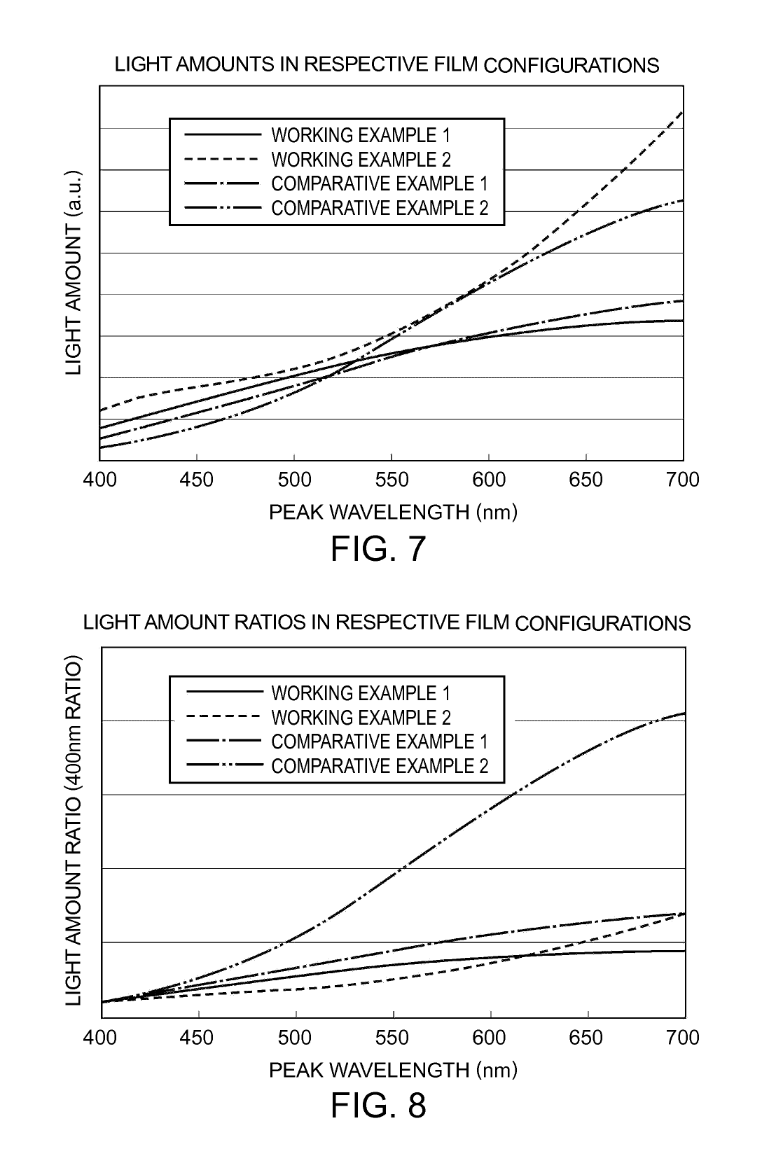

Next, FIGS. 7 and 8 show evaluation results of comparisons between working examples 1, 2 and comparative examples 1, 2. Note that the film thickness dimensions are set so that the reflectance at the reference wavelength λ₀=560 nm may be 91% in all examples.

### Working Example 1

Working example 1 is an example in which the film thicknesses of the TiO₂ films 57 of the fixed mirror 54 and the movable mirror 55 are set to 0.2Q. Specifically, an etalon was manufactured with the film thickness dimension T of the TiO₂ film 57 set to 11 nm and the film thickness dimension S of the Ag alloy film (AgSmCu alloy film) 58 set to 44 nm.

### Working Example 2

Working example 2 is an example in which the film thicknesses of the TiO₂ films 57 of the fixed mirror 54 and the movable mirror 55 are set to 1.6Q. Specifically, an etalon was manufactured with the film thickness dimension T of the TiO₂ film 57 set to 90 nm and the film thickness dimension S of the Ag alloy film (AgSmCu alloy film) 58 set to 37 nm.

### Comparative Example 1

Comparative example 1 is an example in which a single film of the Ag alloy film 58 is formed. That is, a single film of an Ag—Sm—Cu alloy film was formed on a glass substrate and an etalon was manufactured with the film thickness dimension S set to 41 nm.

### Comparative Example 2

Comparative example 2 has a configuration of a reflection film in the past, that is, an example in which a laminated structure of a TiO₂ film and a silicon dioxide (SiO₂) film is formed and an Ag—Sm—Cu alloy film is formed on the laminated structure in the order from the substrate side. In this regard, an etalon was manufactured with the film thickness dimension of the TiO₂ film set to 23 nm, the film thickness dimension of the SiO₂ film set to 37 nm, and the film thickness dimension of the Ag—Sm—Cu alloy film set to 41 nm.

### Evaluations

FIG. 7 shows the amounts of lights in the respective film configurations of working examples 1, 2 and comparative examples 1, 2, and FIG. 8 shows light amount ratios with reference to the amount of light at 400 nm.

As shown in FIG. 8, in comparative example 2, the light amount ratio at 700 nm compared to the amount of light at 400 nm is largely different by about 21 times. On the other hand, the ratio may be suppressed to about 6.9 times in comparative example 1 and the ratio may be suppressed to about 6.9 times in working example 2, and further, in working example 1, the ratio may be suppressed to about 4.5 times.

Therefore, according to working examples 1, 2, the change rate of the output (light reception intensity) of the light receiving device 31 in the range from the shorter wavelength range to the longer wavelength range may be made smaller, the power of the amplifier in the shorter wavelength range with the lower output may be made lower than that of the comparative example 2, the increase of the noise component may be suppressed, and thereby, high-accuracy measurement results with the higher S/N ratio may be obtained.

Further, by using the film thickness of 0.2Q as in working example 1, the change rate may be made smaller compared to that of comparative example 1, the noise may be suppressed, and thereby, more high-accuracy measurement results may be obtained.

Note that the light amount ratio of the film thickness of 1.6Q of working example 2 is smaller than that of 0.2Q to near 620 nm, however, the light amount ratio sharply rises at the longer wavelength range side. This is caused by the increase of the amount of transmission light from near 600 nm in working example 2 as shown in FIG. 5.

Here, in working example 2, the larger amount of light at 400 nm is secured as shown in FIG. 7. Therefore, in the wavelength range of 600 nm or more, a light amount adjustment filter may be used for reduction of the whole difference in light amount. In this manner, the difference in light amount ratio in the visible light range may be made smaller than that of comparative example 1, the noise may be suppressed, and thereby, more high-accuracy measurement results may be obtained.

The entire disclosure of Japanese Patent Application No. 2011-032149, filed Feb. 17, 2011 is expressly incorporated by reference herein.

What is claimed is:

1. A tunable interference filter comprising:
a first substrate;
a second substrate opposed to the first substrate;
a first reflection film provided on a surface of the first substrate facing the second substrate;
a second reflection film provided on the second substrate and opposed to the first reflection film via a gap; and
a gap dimension setting unit that sets a dimension of the gap by changing the dimension of the gap,
wherein the first reflection film and the second reflection film are respectively formed by stacking one layer of a transparent film and one layer of a metal film,
a film thickness of the transparent film and a film thickness of the metal film are set to film thicknesses such that reflectance of the reflection film at a reference wavelength set in advance may be target reflectance set in advance and reflectance of a set wavelength set in a shorter wavelength range in a transmission wavelength range may be lower than reflectance at the set wavelength if the reflection film is formed only by the metal film and the reflectance of the reference wavelength is set to the target reflectance, and
light having a wavelength in response to the dimension of the gap set by the gap dimension setting unit is transmitted.

2. The tunable interference filter according to claim 1, wherein the first reflection film is formed by sequentially stacking one layer of the transparent film and one layer of the metal film from the first substrate side, and
the second reflection film is formed by sequentially stacking one layer of the transparent film and one layer of the metal film from the second substrate side.

3. The tunable interference filter according to claim 1, wherein the metal film is an Ag alloy film containing silver (Ag) as a main component.

4. The tunable interference filter according to claim 1, wherein the transparent film is a titanium dioxide (TiO₂) film.

5. The tunable interference filter according to claim 1, wherein the first substrate and the second substrate are glass substrates, and
a refractive index of the transparent film is higher than refractive indices of the first substrate and the second substrate.

6. An optical module comprising:
the tunable interference filter according to claim 1; and
a light receiving unit that receives test object light transmitted through the tunable interference filter.

7. A photometric analyzer comprising:
the optical module according to claim 6; and
an analytical processing unit that analyzes light properties of the test object light based on the light received by the light receiving unit of the optical module.

8. A tunable interference filter comprising:
a first reflection film; and
a second reflection film opposed to the first reflection film via a gap,
wherein the first reflection film and the second reflection film are respectively formed by stacking one layer of a transparent film and one layer of a metal film,
a film thickness of the transparent film and a film thickness of the metal film are set to film thicknesses such that reflectance of the reflection film at a reference wavelength set within a transmission wavelength range may be set target reflectance and reflectance at a set wavelength set in a shorter wavelength range in the transmission wavelength range may be lower than reflectance at the set wavelength if the reflection film is formed only by the metal film and the reflectance of the reference wavelength is set to the target reflectance.

9. A tunable interference filter comprising:
a first reflection film; and
a second reflection film opposed to the first reflection film via a gap,
wherein the first reflection film and the second reflection film are respectively formed by stacking one layer of a transparent film and one layer of a metal film, and
a film thickness of the transparent film is set to a film thickness such that reflectance at one wavelength in a shorter wavelength range in a transmission wavelength range may be lower than reflectance at the wavelength if the reflection film is formed only by the metal film.

10. A tunable interference filter comprising:
a first reflection film; and
a second reflection film opposed to the first reflection film via a gap,
wherein the first reflection film and the second reflection film are respectively formed by stacking one layer of a transparent film and one layer of a metal film, and the transparent film is a titanium dioxide (TiO₂) film having a film thickness taking a value of ranges from 11 to 19 nm, from 73 to 104 nm, and from 162 to 177 nm.
